(19) United States
(12) Patent Application Publication
(10) Pub. No.: US 2015/0173385 A1
(43) Pub. Date: Jun. 25, 2015

(54) Snack-Type Dry Cheese Food Product And Process For Manufacturing Same

(71) Applicant: Bongrain SA, Viroflay (FR)

(72) Inventors: Claude Oustric, Chartainvilliers (FR); Didier Beudon, Rambouillet (FR)

(73) Assignee: Bongrain SA, Viroflay (FR)

(21) Appl. No.: 14/162,366

(22) Filed: Jan. 23, 2014

(30) Foreign Application Priority Data
Dec. 20, 2013 (FR) 13 63224

(51) Int. Cl. A23C 19/14

(52) U.S. Cl. CPC A23C 19/14

(57) ABSTRACT

The present invention relates to a snack-type dry cheese food product and to the process for manufacturing same.

### FIELD

The present invention relates to the field of the food industry; it is directed more particularly towards a snack-type dry cheese food product and the process for manufacturing same.

### BACKGROUND

A large variety of snack-type food products exist on the market; the term “snack-type food product” is intended to mean foods of small size; that is to say representing an individual portion which can be ingested in one or more mouthfuls and is generally intended to be eaten with the fingers. Most of the commercially available dry, snack-type foods with a savoury taste are essentially composed of carbohydrates, of added flavourings and of fats (such as crisps, blown or extruded products); they are of very limited nutritional value, which is why the consumption of this type of product is often criticized.

### SUMMARY

The Applicant has developed a novel snack-type dry cheese food product which is prepared exclusively from cheese or from a cheese speciality product. Surprisingly, the applicant has succeeded in transforming, by means of an original process, cut pieces of low-fat cooked pressed cheese into a hollow-shaped expanded dry snack which has a crunchy texture; the preparation of this novel product does not require the addition of any additional ingredient; the food product obtained is very dry, rehydrates very little and thus keeps a crunchy texture and the desired effect in the mouth.

The subject of the present invention is thus a process for manufacturing a dry cheese food product comprising the following steps:
a) Freezing a cheese to a temperature of less than or equal to −20° C.; said cheese has a fat content of less than or equal to 40% by weight, this fat content preferably being between 3% and 25%, and more preferentially between 5% and 16% by weight, and is prepared beforehand in slices having a thickness of less than or equal to 4 mm, preferably between 0.1 and 2 mm, and more preferentially between 0.5 and 1.5 mm;
b) Placing said frozen cheese under vacuum at a pressure of between 0.1 and 100 mbar;
c) Heating said frozen cheese under vacuum in two phases:

c1) Phase 1: rapid increase in the temperature of said cheese to a temperature of the order of 120° C., over the course of 0.2 to 2 hours, at a pressure of between 0.1 and 100 mbar and a water vapour extraction flow of 0.4 to 10 kg of water per kg of product and per hour; and

c2) Phase 2: cooking at a temperature of between 60 and 160° C., at a pressure of between 0.1 and 100 mbars and for 5 to 60 minutes;
d) Cooling under vacuum, at a pressure of between 0.1 and 100 mbar, to a temperature of between 40 and 80° C. at a temperature reduction speed of between 50 and 70° C. per hour;
e) Pressurizing by vacuum compensation with a dry gas, i.e. a gas having a moisture content of less than 3 ppm, preferably nitrogen gas.

The set temperature and pressure values applied during processing phase c2 make it possible to adjust the sensory quality of the final product: colour, texture, flavour, according to the desired target. These set values can be variable over time.

### BRIEF DESCRIPTION OF THE FIGURES

FIGS. 1 and 2 are photographs of dry cheese food products according to the invention which have, respectively, a rectangular profile and a triangular profile.

FIG. 3 shows a cross section of a dry cheese food product; this image clearly shows the hollow “cushion” shape of said product.

FIG. 4 shows a flow chart of an exemplary process for preparing a dry cheese food product in accordance with an embodiment of the invention.

### DETAILED DESCRIPTION

The term “cheese” is intended to mean a cooked pressed cheese or a cheese spread.

Among the low-fat cooked pressed cheeses usable in the process of the invention, mention may be made of Fol Epi light, Leerdammer light, low-fat Emmental and Holland Cheese Master light.

The process according to the invention can also be carried out using cheese spread obtained from a mixture of cooked pressed cheeses, uncooked pressed cheeses, milk powder, caseinate powder, dairy cream, etc., in the presence of less than 3% of sodium citrate.

According to one variant of the invention, the cheese, or the cheese spread, can also comprise up to 5% by weight, relative to the total weight of cheese, of flavourings, seasoning or markers, for modifying the taste, the flavour and the final appearance of the product.

The advantage of the use of cheese spread is that its preparation makes it possible to control, and in particular to reduce, the fat content of the final product.

The cheese used preferably has a minimum CO₂ content of 5 mmol/kg; this minimum CO₂ content comes from a propionic fermentation which occurs during the manufacturing of said cheese or else from an incorporation of CO₂ after the manufacturing of said cheese, in the form of gas or of carbonate.

The cheese pieces can have any shape as long as they are less than 4 mm thick; the sizes of the cheese pieces will preferably be such that the dry cheese food product obtained can be ingested in one or two mouthfuls, i.e. forming within a rectangle having a width of between 0.1 and 3 cm, and preferably between 1 and 3 cm, and a length of between 0.1 and 10 cm and preferably between 1 and 10 cm.

The preparation of the cheese pieces can, for example, be carried out by cutting a cheese into slices and then cutting them up with a hole punch; alternatively, when the cheese used is a cheese spread, it can be formed at a temperature of between 45 and 70° C., and then passed through a die having the desired shape (extrusion) for the final cheese piece, and cut into pieces having a thickness of less than or equal to 4 mm.

The heating of the frozen cheese pieces under vacuum is carried out in two phases: the first phase consists of a rapid increase in the temperature and enables expansion of the cheese slices, the second is a cooking phase during which the taste develops.

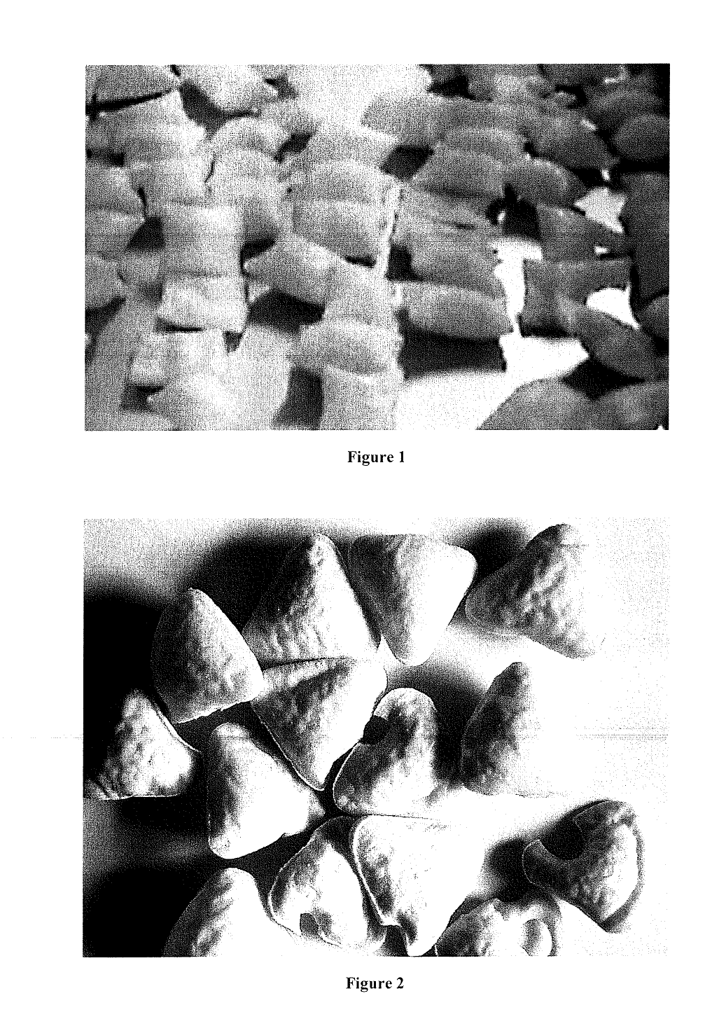

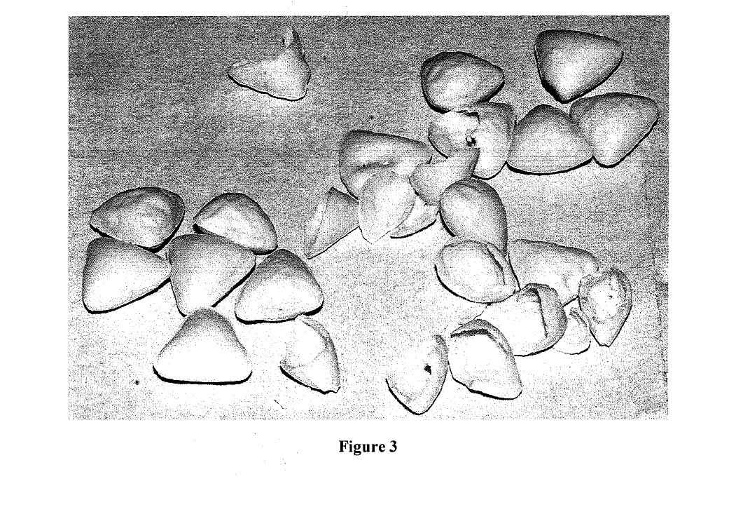

From a geometrical point of view, the dry cheese food product obtained by means of this process is characterized by dimensions within the same ranges as those of the cheese slices used as starting product in the process according to the invention; the process confers on the product a three-dimensional cushion shape, i.e. it is hollow with two convex faces and fused edges; this characteristic structure is represented in FIGS. 1 and 2 which show, respectively, pieces with a rectangular profile and pieces with a triangular profile; FIG. 3 also illustrates the hollow cushion shape of the product according to the invention.

In terms of composition, the dry cheese food product is a lyophilized milk product, preferably a lyophilized cheese, as previously defined, characterized by:

a low water activity (a_{w}), i.e. between 0.1 and 0.4;

a cheese taste originating from the natural flavours of the cheese used;

a protein/fat weight ratio which has been preserved with respect to the starting product.

Finally, from the organoleptic point of view, this product is characterized by a very crunchy texture, demonstrated in sensory tests by comparison with reference products (see example II hereinafter).

The product obtained has the advantage of being able to be consumed directly without any other processing, and in particular without seasoning. It is therefore a product without added salt or fat which has the same nutritional value as the cheese from which it is manufactured; in particular, it is possible to prepare dry cheese food products having a high protein content, i.e. greater than or equal to 30%, preferably greater than or equal to 50%, more preferentially greater than or equal to 60% by weight of total proteins relative to the total weight of the product. In addition, the product according to the invention has a very low carbohydrate content and represents a better nutritional intake than carbohydrate-based snacks and crisps.

The dry cheese food products according to the invention can be consumed alone or as an accompaniment in dishes such as soups or salads; they can also be consumed after dipping in a pasty preparation of guacamole, houmous or taramasalata type; in this case, they preferably have a rectangular shape.

The use of the dry cheese food products according to the invention is not limited to human food, but can also relate to animal feed, whether this involves farm animals or domestic animals.

### Example I

### Preparation of a Dry Cheese Food Product According to the Invention

### Implementation

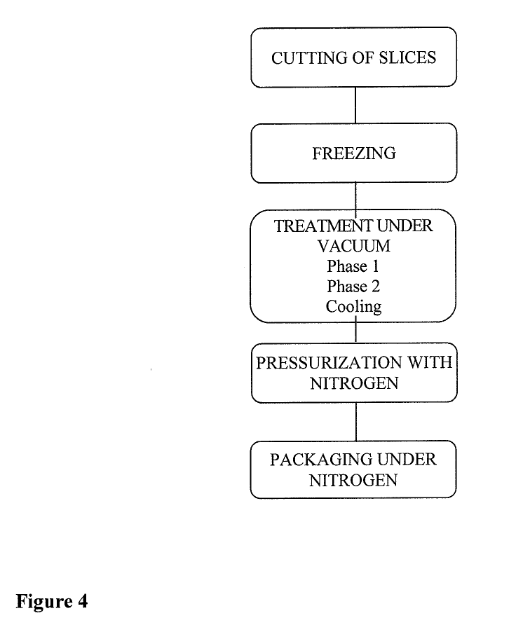

With reference to FIG. 4, a flow chart of an exemplary process for preparing a dry cheese food product in accordance with an embodiment of the invention is illustrated. Approximately 25 mm-sided, triangular-shaped cheese pieces with rounded edges, in slices approximately 1 mm thick, are prepared from low-fat cooked pressed cheese of Fol Epi Light type.

The pieces are placed on 39×48 cm sheets and placed in a freezer at −55° C. for 2 hours.

The sheets of frozen cheese are placed in a lyophilizer.

A programming table makes it possible to carry out the desired processing phases:
Heating cycle automatically initiated after the target pressure of 0.2 mbar has been reached in the processing chamber.
Heating resistors rapidly brought to temperature at 120° C. (0 to 30 min).
Heating temperature maintained at 120° C. for 1 hour.
Cooling to 60° C., after 1 hour.
Placed under atmospheric pressure by adding nitrogen.

### Example II

### Evaluation of the Crunchiness of a Dry Cheese Food Product According to the Invention

The sensory impression of the crunchiness of the dry cheese food product manufactured according to example I is evaluated by a panel of judges in comparison with commercial snacks.

The commercial snacks tested include Benenuts natural flavour “3D Bugles”, Belin cheese “P'tit Belin”, Tuc Original “Mini Snackies” and Kelloggs Original “Pringles”.

The following were evaluated by the judges:
the overall impression of crunchiness perceived while eating the piece of product tested:

The dry cheese food product according to the invention and “3D Bugles” are perceived as being the crunchiest products as an overall impression; the results obtained for these two products are not significantly different;
the number of successive times the tested product was chewed with a significant noise being perceived:

The noise descriptor gives a product classification similar to that of the overall impression of crunchiness and the two products which have the highest score are the dry cheese food product according to the invention and “3D Bugles” (no significant difference between these two products).

It emerges from these sensory studies that the dry cheese food product according to the invention can be described as very crunchy since it is classified equal with the crunchiest market product tested.

### Example III

### Preparation of a Dry Cheese Food Product According to the Invention

Preparation of a cheese spread according to the following composition:

| Constituent | Content (%) |
|---|---|
| Fol Epi Light | 50 |
| Edam 30 | 20 |
| Crème fraiche | 10 |
| Calcium caseinate | 3 |
| Skimmed milk powder | 4 |
| Sodium citrate | 2.2 |
| Calcium carbonate | 0.3 |
| Water | 10.5 |

Approximately 25 mm-sided triangular shapes with rounded edges are formed and then cut into slices approximately 1 mm thick.

The processing flowchart is the same as for example I.

The pieces are placed on 39×48 cm sheets and placed in a freezer at −55° C. for 2 hours.

The sheets of frozen cheese are placed in a lyophilizer.

A programming table makes it possible to carry out the desired processing phases:
Heating cycle automatically initiated after the target pressure of 0.2 mbar has been reached in the processing chamber.
Heating resistors rapidly brought to temperature at 120° C. (0 to 30 min).
Heating temperature maintained at 120° C. for 1 hour.
Cooling to 60° C., after 1 hour.
Placed under atmospheric pressure by adding nitrogen.

1. Process for manufacturing a dry cheese food product comprising the following steps:
a) Freezing a cheese to a temperature of less than or equal to −20° C.; said cheese has a fat content of less than or equal to 40%, and is prepared beforehand in slices having a thickness of less than or equal to 4 mm;
b) Placing said frozen cheese under vacuum at a pressure of between 0.1 and 100 mbar;
c) Heating said frozen cheese under vacuum, in two phases:
c1) Phase 1: rapid increase in the temperature of said cheese to a temperature of the order of 120° C., over the course of 0.2 to 2 hours, at a pressure of between 0.1 and 100 mbar and a water vapour extraction flow of 0.4 to 10 kg of water per kg of product and per hour; and
c2) Phase 2: cooking at a temperature of between 60 and 160° C., at a pressure of between 0.1 and 100 mbars and for 5 to 60 minutes;
d) Cooling under vacuum, at a pressure of between 0.1 and 100 mbar, to a temperature of between 40 and 80° C. at a temperature reduction speed of between 50 and 70° C. per hour;
e) Pressurizing by vacuum compensation with a dry gas.

2. Process according to claim 1, wherein said cheese has a minimum CO₂ content of 5 mmol/kg.

3. Process according to claim 1, wherein said cheese is a light cooked pressed cheese or a cheese spread.

4. Process according to claim 1, wherein said cheese is chosen from Fol Epi light, Leerdammer light, low-fat Emmental or Holland Cheese Master light.

5. Dry cheese food product capable of being obtained by means of the process according to claim 1.

6. Dry cheese food product comprising is a lyophilized milk product and by:
a water activity (a_{w}) of between 0.1 and 0.4;
a size such that its width is between 0.1 and 3 cm and its length is between 0.1 and 10 cm;
a hollow three-dimensional cushion shape with two convex faces and fused edges; and
a crunchy texture.

7. Dry cheese food product according to claim 6, wherein said milk product is a cooked pressed cheese or a cheese spread which has a fat content of less than or equal to 40%.
